(19) United States
(12) Patent Application Publication
(10) Pub. No.: US 2005/0189674 A1
(43) Pub. Date: Sep. 1, 2005

(54) Method of making a sandwich-type composite panel having a hinge, and panel obtained by performing such method

(75) Inventors: Nicolas Hochet, La Chapelle Sur Oudon (FR); Francis Vendangeot, Chateaubriant (FR)

Correspondence Address: BROOKS KUSHMAN P.C., 1000 TOWN CENTER, TWENTY-SECOND FLOOR, SOUTHFIELD, MI, 48075, US

(73) Assignee: PEGUFORM FRANCE, SAINT-MARCEL (FR)

(21) Appl. No.: 11/096,654

(22) Filed: Apr. 1, 2005

Related U.S. Application Data
(62) Division of application No. 09/445,356, filed on Mar. 1, 2000, now abandoned.

(30) Foreign Application Priority Data
Apr. 10, 1998 (FR) 98/04556

(51) Int. Cl. B29C 67/20

(52) U.S. Cl. 264/138; 264/321; 264/322; 264/257

(57) ABSTRACT

The invention relates to a method of making a composite panel (100) of sandwich structure and provided with a hinge (106), said panel comprising a stack made up of at least one first skin (101) made of a reinforced thermoplastics material, of a cellular core (102) made of a thermoplastics material, and of a second skin (103) made of a thermoplastics material, in which method said panel (100) is formed by pressing said stack at a pressure lying in the range 10×10⁵ Pa to 30×10⁵ Pa, the first and second skins (101, 103) being preheated to a softening temperature. The invention is characterized in that, after said panel has been formed, an incision is made at a determined place in said panel so as to cut through one (101) of the first and second skins (101, 103), and substantially through the entire thickness of the cellular core, while leaving the other skin (103) intact so that it forms, at said place, the hinge (106) between two portions (107, 108) of the incised panel (100).

The present invention relates generally to panels of sandwich-type composite structure having a cellular core, in particular for motor vehicles, and more particularly to a method of making such a panel provided with a hinge.

Sandwich-type materials having cellular cores have very important characteristics resulting from their being light in weight.

Conventionally, such a panel is constructed by sandwiching a cellular core having low strength characteristics by gluing it or welding it between two skins, each of which is much thinner than the cellular core but has excellent mechanical characteristics.

In addition, the Applicant's document FR 2 711 573 discloses a method of making a panel of sandwich-type composite structure having a cellular core. In that method, said panel is made in a single step by subjecting a stack to cold-pressing in a mold, which stack is made up of at least a first skin made of a stampable reinforced thermoplastics material, of a cellular core made of a thermoplastics material, of a second skin made of a stampable reinforced thermoplastics material, and of a first external covering layer made of a woven or non-woven material, said skins being pre-heated outside the mold to a softening temperature.

Such a method is particularly advantageous because of the fact that it makes it possible, in a single operation, to generate cohesion between the various layers of the composite structure, and to shape said panel.

The resulting panel conserves all of the mechanical properties imparted by the cellular-core sandwich structure.

Panels of sandwich-type composite structure having a cellular core have rigidity characteristics sufficient to enable mechanical structures subjected to large stresses to be reinforced structurally without making them too heavy. Such panels are in common use in shipbuilding, aircraft construction, and rail vehicle construction.

However, such panels are rarely used as such.

To maximize the functionality of such panels, it is known, in particular, that hinges can be added so that the panels can be hinged to other panels. Such hinges are separate parts that are fixed to the panels by gluing, welding, riveting, or some other fastening technique.

Such hinges are fixed to the sandwich-structure composite panels in a separate and subsequent operation, after said panels have been formed. That subsequent operation requires an additional workstation, be it automated or otherwise, which increases, in particular, the manufacturing time and the manufacturing cost of the finished parts.

In addition, the fact that separate external parts are mounted on a composite panel of the sandwich type is a source of quality defects, and thus adds to the cost of making such panels.

To mitigate the drawbacks of the above-mentioned state of the art, the invention proposes a novel method of making a composite panel of sandwich structure and provided with a hinge, which method is simple to implement, requires no additional subsequent operation, and thus makes it possible to manufacture such parts at a reasonably low cost.

More particularly, the invention provides a method of a method of making a composite panel of sandwich structure and provided with a hinge, said panel comprising a stack made up of at least one first skin made of a reinforced thermoplastics material, of a cellular core made of a thermoplastics material, and of a second skin made of a thermoplastics material, in which method said panel is formed by pressing said stack at a pressure lying in the range 10×10⁵ Pa to 30×10⁵ Pa, the first and second skins being preheated to a softening temperature.

The method is characterized in that, after said panel has been formed, an incision is made at a determined place in said panel so as to cut through one of the first and second skins, and substantially through the entire thickness of the cellular core, while leaving the other skin intact so that it forms, at said place, the hinge between two portions of the incised panel.

The expression “substantially through the entire thickness of” is used to mean that the cellular core is cut through over a distance lying in the range 80% of its total thickness to 100% of its total thickness.

The method of the invention goes against the preconceptions of the person skilled in the art who believes that, if the structural integrity of the sandwich material is not maintained, it will not retain all of its mechanical capacities, and who believes that a skin made of a thermoplastics material reinforced with glass fibers, carbon fibers, or natural fibers is not strong enough to constitute a structural hinge because of the use of fibers.

It is known that a thermoplastics material can be used to make a hinge that does not provide structural strength or at least not much structural strength, but, in the mind of the person skilled in the art, adding glass fibers to a thermoplastics material makes it too weak to use for this function.

The invention also provides a method of this type for making a composite panel of sandwich structure and provided with a hinge, said method being characterized in that, simultaneously with the forming of said panel, at least a portion of an edge of said panel is crushed so as to compact the cellular core, and the crushed portion of the edge is cut out to a desired shape so as to obtain a hinge-forming piece suitable for being fixed to another panel.

In an advantageous implementation of the above-mentioned method, the crushed-edge portion is cut out at the end of forming of said panel.

In a variant, the crushed edge portion is cut out immediately after said panel has been formed.

In order to make this hinge using the method of the invention, the principle that governs the making of a sandwich material, whereby the required spacing between the skins must be maintained, is disregarded, but the crushing of the edge of the panel makes it possible to increase its traction strength considerably because the sheared area of said edge is thus statistically increased, by removing the empty spaces in the cellular core.

According to other non-limiting and advantageous characteristics of the method of the invention, prior to forming said panel, a pre-assembly constituted by the stack of at least the first skin, of the cellular core and of the second skin is heated such that, while said panel is being formed, the first and second skins have a forming temperature lying approximately in the range 160° C. to 200° C.

The first and second skins are made up of glass fiber fabric and of a thermoplastics material. The thermoplastics material may be a polyolefin and preferably polypropylene.

The cellular core of the panel advantageously has an open-celled structure of the tubular or honeycomb cell type.

Naturally, in the invention, it is also possible to use a cellular structure having closed cells of the foam type.

The invention also provides a panel of sandwich-type composite structure and comprising a stack made up of at least a first skin, of a cellular core made of a thermoplastics material, and of a second skin, the panel being provided with at least one hinge, and being made by implementing the above-mentioned method.

The invention and how it may be implemented can be well understood from the following description given with reference to accompanying drawings which are given by way of non-limiting example, and in which:

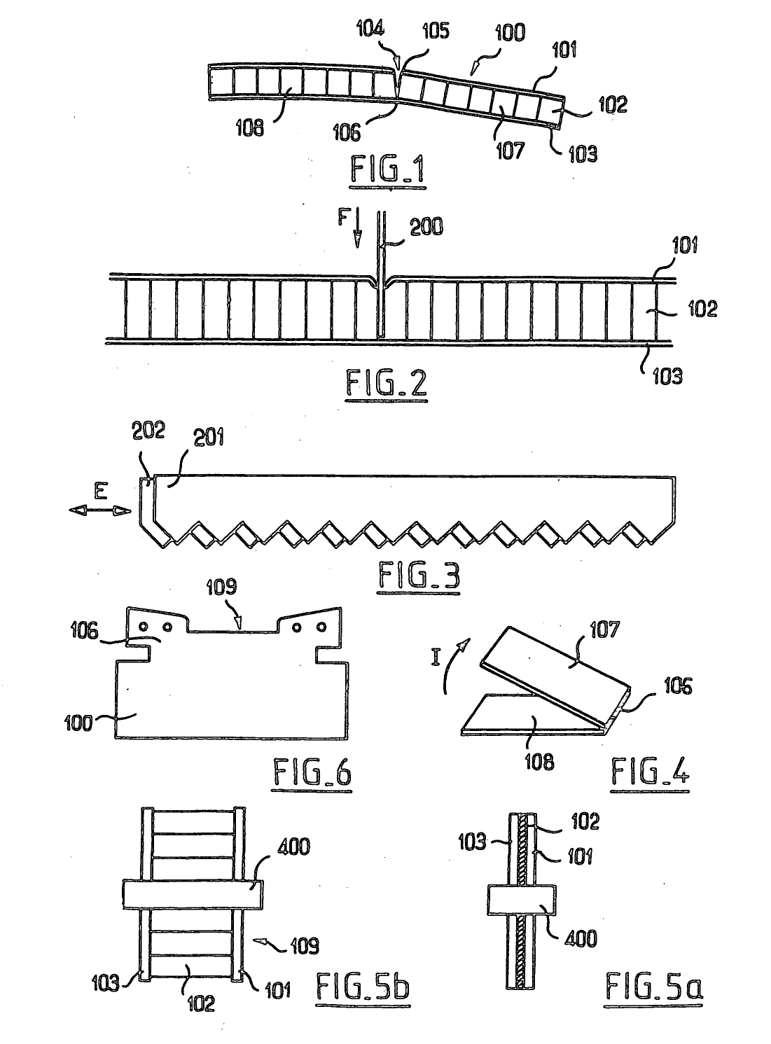

FIG. 1 is a first embodiment of a sandwich-structure composite panel provided with a hinge, and made using the method of the invention;

FIG. 2 shows a step in performing an implementation of the method of the invention;

FIG. 3 is a side view of a double serrated blade used in the method of the invention;

FIG. 4 shows a test installation for a sandwich-structure composite panel provided with a hinge, and made using the method of the invention;

FIGS. 5a and 5b show a sandwich material as crushed and a sandwich material as non-crushed, in which a fixing screw is inserted; and

FIG. 6 is a diagrammatic front view of a second embodiment of a sandwich-structure composite panel made using the method of the invention.

FIG. 1 shows a panel 100 of sandwich-type composite structure made up of a stack comprising a first skin 101 made of a reinforced thermoplastics material, a cellular core 102, and a second skin 103 made of a reinforced thermoplastics material.

The first and second skins 101, 103 are reinforced with fibers, e.g. glass fibers, carbon fibers or natural fibers.

The first and second skins 102, 103 may advantageously be made up of woven glass fiber fabric and of a thermoplastics material.

The thermoplastics material is a polyolefin and preferably polypropylene.

In this example, the cellular core 102 is an open-celled structure of the type made up of tubes or of a honeycomb, and it is made mainly of polyolefin and preferably of polypropylene. Naturally, it is possible to use a cellular structure having closed cells of the foam type.

One side or both sides of the panel 100 may be covered with an outer covering (not shown) made of a woven or non-woven material (of the carpet type).

In the method of making such a panel, the panel 100 is formed by pressing a stack in a cold-forming mold, the stack being made up of the first skin 101, of the cellular core 102, and of the second skin 103, and being pressed at a pressure lying in the range 10×10⁵ Pa to 30×10⁵ Pa.

The first and second skins 101, 103 are pre-heated to make them malleable.

Advantageously, in order to soften the first and second skins, heat is applied to a pre-assembly constituted by the stack made up of at least the first skin 101, of the cellular core 102, and of the second skin 103 so that, while said panel is being formed, the first and second skins have a forming temperature lying approximately in the range 160° C. to 200° C., and, in this example, about 180° C.

As shown in FIG. 1, the panel 100 is provided with an incision 104 at a determined place that, in this example, is substantially central.

This incision 104 is made after the panel 100 has been formed, and more particularly in the range 10 to 30 seconds after it has been formed, so as to cut through the first skin 101 and through substantially the entire thickness of the cellular core 102, while the second skin 103 is left intact so that, at said determined place, it forms a hinge 106 between two portions 107, 108 of the incised panel.

A serrated blade 200 (see FIG. 2) is advantageously used to make an incision. The size of the serrations and the height of the blade are functions of the thickness of the sandwich material to be cut.

The serrated blade 200 is mounted to move relative to the plane of said panel 100 as formed, the blade moving vertically initially to cut through the fibers of the top first skin 101 without crushing the sandwich material at this place, and then moving vertically and horizontally back-and-forth relative to the plane of said panel so as to cut through the entire thickness of the cellular core.

The time interval of in the range 10 seconds to 30 seconds between the panel-forming operation and the panel-incision operation enables the thermoformed panel to cool sufficiently for the serrated blade 200 to cut the fibers of said skin properly without crushing the sandwich material.

It is possible to make provision for the incision made in the panel 100 by means of the blade 200 to be effected inside the forming mold or outside the forming mold. When the operation is performed inside the forming mold, the serrated blade 200 is mounted on a moving portion of a portion of the mold that, after the panel has been formed, is displaced relative to the mold so as to effect the panel incision operation.

In a variant of the method of making said panel, it is possible to use two serrated blades 201, 202 (see FIG. 3) which vibrate as indicated by arrow E relative to each other, while moving vertically relative to the plane of said panel, so as to make the incision 104 as shown in FIG. 1.

It is particularly advantageous to use two serrated blades for cutting a skin that is thick or difficult to cut because of the use of fibers and of the type of its weave.

Tests were conducted in situ on such a panel having a hinge by means of testpieces, such as the one shown in FIG. 4. The tests were conducted firstly with panels in which each of the skins was constituted by woven fabric comprising glass fibers embedded in polypropylene and had a weight per unit area of 915 g/m², and the cellular core had honeycomb cells and was made of polypropylene, and secondly with panels in which each of the first and second skins had a weight per unit area of 1,000 g/m².

The serrated blade used for making the incisions in the panels had a thickness of 0.5 mm.

Immediately after compression, the forming mold was opened rapidly so as to insert the blade and fix it on a punch, and then the mold was closed again. The opening and closure times enabled the formed panels to cool sufficiently.

The testpieces (one of which is shown in FIG. 4) were fatigue tested by performing opening and closure cycles as indicated by arrow I, the opening amplitude varying from a minimum of 3 degrees to a maximum of 45 degrees.

The test results obtained showed that certain testpieces were torn at the hinge-forming skin after 3,000 cycles because a score line was generated on mounting the testpieces on the test bench.

However, the carpet that covered the skins of said testpieces still held the two portions of panel together.

The testpieces that were not damaged on mounting them on the test bench withstood 30,000 cycles without breaking. This corresponds to about eight openings per day for ten years.

FIG. 6 shows another sandwich-type composite panel 100 which comprises a stack made up of at least one first skin made of a reinforced thermoplastics material, of a cellular core made of a thermoplastics material, and of a second skin made of a reinforced thermoplastics material of the same type as those described above. The panel 100 is formed by being pressed at a pressure lying in the range 10×10⁵ Pa to 30×10⁵ Pa, said first and second skins being preheated to a softening temperature so that, while the panel is being formed, they have a temperature approximately in the range 160° C. to 200° C.

This panel 100 is provided with a hinge 106 cut out in one of its edges 109.

Depending on the method used, after the panel has been formed, at least a portion of the edge 109 of the panel is crushed so as to compact the cellular core 103 at this place. This crushing is performed by a projection provided at the appropriate place on a portion of the mold.

Said edge being crushed causes the sandwich structure to be compacted as shown in diagrammatic section in FIG. 5a.

This crushed sandwich structure can be compared with the non-crushed sandwich structure shown in FIG. 5b.

It can be observed from FIGS. 5a and 5b which show a screw 400 inserted through each of the sandwich composite structures that, in the crushed composite structure, the shear area of the screw is larger than the shear area of the screw inserted through the non-crushed structure since, in the non-crushed structure, the screw passes through the non-crushed cellular core via one of the cells in the core, and therefore the shear area corresponds merely to the areas of the first and second skins.

Thus, advantageously, in the method of the invention, the fact that a portion of the edge 106 of the panel 100 is crushed makes it possible to increase its traction strength.

In order to form the hinge 106 shown in FIG. 6, the crushed edge 109 is cut out to the desired shape.

The crushed edge 109 is preferably cut out at the end of the panel-forming operation, but it may also be cut out immediately after the panel-forming operation, which then makes it necessary for the forming mold to be specially organized to prevent the edge of the panel from being cut at the end of forming of said panel.

The panel 100 then has a hinge 106 formed in one piece with it, and which is suitable for being fixed to another part or to another panel to enable one panel to be hinged relative to the other.

The method mentioned and described above in two of its variants offers the following advantages:
it makes it possible to form a hinge in situ in a sandwich-structure composite panel without any separate subsequent operation being necessary, without using any additional part, or any additional material of the glue type for fixing the additional part, thereby making it possible to reduce considerably the cost of manufacturing the finished part;
the method makes it possible to omit any additional machine of the gluing or welding type; and
it makes it possible to make the panel with its integrated hinge in a time shorter than the time required to make a panel provided with a separate hinge.

The present invention is in no way limited to the implementations described and shown, but rather the person skilled in the art can make any variants thereto that lie within the spirit of the invention.

1-6. (canceled)

7. A method of making a composite panel (100) of sandwich structure and provided with a hinge (106), said panel comprising a stack made up of at least one first skin made of a reinforced thermoplastics material, of a cellular core made of a thermoplastics material, and of a second skin made of a reinforced thermoplastics material, in which method said panel is formed by pressing said stack at a pressure lying in the range 10×10⁵ Pa to 30×10⁵ Pa, the first and second skins being preheated to a softening temperature, said method being characterized in that, simultaneously with the forming of said panel (101), at least a portion of an edge (109) of said panel is crushed so as to compact the cellular core (102), and the crushed portion of the edge (109) is cut out to desired shape so as to obtain a hinge-forming piece (106) suitable for being fixed to another panel.

8. A method according to claim 7, characterized in that the portion of the crushed edge (109) is cut out at the end of forming of said panel (100).

9. A method according to claim 7, characterized in that the portion of the crushed edge (109) is cut out immediately after said panel (100) has been formed.

10. A method according to claim 7, characterized in that, prior to forming said panel (100) a pre-assembly constituted by the stack of at least the first skin (101), of the cellular core (102) and of second skin (103) is heated.

11. A method according to claim 7, characterized in that, while said panel (100) is being formed, the first and second skins (101, 103) have forming temperature lying approximately in the range 160° C. to 200° C.

12. A method according to claim 7, said method being characterized in that the first and second skins (101, 103) are made up of glass fiber fabric and a thermoplastics material.

13. A method according to claim 12, characterized in that the thermoplastics material is a polyolefin and preferably polypropylene.

14. A method according to claim 7, characterized in that the cellular core (102) of the panel (100) has an open-celled structure of the tubular or honeycomb cell type.

15. A panel (100) of sandwich-type composite structure and comprising a stack made up of at least a first skin (101) made of a reinforced thermoplastics material, of a cellular core (102) made of a thermoplastics material, and of a second skin (103) made of a reinforced thermoplastics material, the panel being provided with at least one hinge, and being made by implementing the method according to claim 7.
